(19) United States
(12) Patent Application Publication
(10) Pub. No.: US 2007/0041501 A1
(43) Pub. Date: Feb. 22, 2007

(54) Apparatus and a method for visualizing target objects in a fluid-carrying pipe

(76) Inventors: Einar Ramstad, Stavanger (NO); Phil Teague, Hafrsfjord (NO)

Correspondence Address: MARGER JOHNSON & MCCOLLOM, P.C., 210 SW MORRISON STREET, SUITE 400, PORTLAND, OR, 97204, US

(21) Appl. No.: 10/570,190

(22) PCT Filed: Aug. 26, 2004
(86) PCT No.: PCT/NO04/00252

§ 371 Date: Oct. 4, 2006

(30) Foreign Application Priority Data
Aug. 29, 2003 (NO) 20033832
Aug. 23, 2004 (NO) 20043504

(51) Int. Cl. G01N 23/223; G21K 5/08; G01N 23/201; G01T 1/36

(52) U.S. Cl. 378/88; 378/66; 378/47

(57) ABSTRACT

An apparatus for recording and displaying images of and identifying material types in a target object in a fluid carrying conduit includes a downhole unit. The downhole unit includes a controllable light source, the controllable light source structured to emit high energy photons. The downhole unit further includes a sensor unit structured to detect the high energy photons that are backscattered from the target object and to generate signals in response to the detected high energy photons. The apparatus also includes a control and display unit that includes a signal transmitter and a viewing screen structured to display at least one two-dimensional image that is generated using the signals from the sensor unit.

This invention regards an apparatus and a method of providing an accurate image of a target object in an exploration or production well or in a pipeline carrying fluids such as hydrocarbons or aqueous liquids, and provides the opportunity of accurately determining which types of material said target object is composed of.

Herein, the term “fluid” is taken to mean any form of liquid and/or gas, separately or mixed.

The environment in exploration and production wells for oil and gas generally prohibits the use of video cameras due to the presence of saline solutions, mud, hydrocarbons and other substances that prevent the passage of visible light. Consequently there exists no apparatus capable of “seeing” the targets under such conditions. The term “see” means making image recordings that can be viewed by the human eye on e.g. a viewing screen, immediately or at a later stage.

This very often results in time-consuming and costly inspections of well formations and equipment, and also fishing operations directed at the removal of unwanted objects in exploration and production wells.

A system is known from U.S. Pat. No. 6,078,867, which produces a three-dimensional image of a borehole by means of a four-armed (or more) downhole calliper and gamma rays.

From U.S. Pat. No. 4,847,814 there is known a system for creating three-dimensional images by using data from a scan of a borehole carried out by use of a rotary acoustic transducer.

EP 1070970 describes a method of three-dimensional reconstruction of a physical quantity from a borehole comprising the creation of a three-dimensional image by measuring a first physical quantity as a function of depth, then to be compared with a second item.

WO 9935490 describes an apparatus and a method of depicting a lined borehole by means of ultrasound.

From U.S. Pat. No. 5,987,385 there is known an acoustic logging tool for creating a peripheral image of a borehole or a well lining by means of ultrasound generated by several transmitters/receivers mounted substantially in the same plane in the end piece of a drill string.

U.S. Pat. No. 4,821,728 describes a three-dimensional imaging system for representation of objects scanned by ultrasound.

U.S. Pat. No. 3,564,251 describes the use of radioactive radiation to establish information about the distance from the apparatus to the surroundings, e.g. a well wall, by creating a radial graph centred on the centre of the apparatus.

Available radiation types range from radio waves via visible light to gamma rays. The wavelength of long-wave radiation in the form of radio waves (>1×10⁻¹ m) is too great to make it possible to create focused images that fulfil the requirements made. Short-wave radiation in the form of gamma rays (<1×10⁻¹¹ m) has a wavelength and an energy level that gives sufficient image quality but require a radiation source in the form of a radioactive material. This is out of the question in the environments for which the invention is intended. Rays having a wavelength between 1×10⁻⁸ m and 1×10⁻¹¹ m have the desired effect both in terms of image quality and the energy level for penetration of relevant fluids.

The object of the invention is to remedy the disadvantages of prior art.

The object is achieved by the characteristics stated in the description below and in the following claims.

The apparatus comprises known and novel technology combined in a novel manner with regard to sensors, electronics, software and assembly.

The possibility of “seeing” in such environments is highly advantageous in terms of fulfilling the requirements for identification and localization of possible material damage and/or undesirable objects that have been lost or are stuck in the borehole.

Today the possibility of “seeing” in such an environment by using a video camera is highly limited, due to the normal mixture of substances in the well.

An apparatus according to the invention will make it possible to provide images of downhole target objects. The invention uses any form of high-energy photon sources to illuminate a target object in order to create an image of the object. Preferably use is made of a light source that emits high-energy photons having a wavelength between 1×10⁻¹¹ m (0.01 nanometres) and 1×10⁻⁸ m (10 nanometres).

The apparatus of the invention may be integrated in various types of downhole tools and make it possible to obtain visual information during critical operations.

Preferably, the recorded measurement data are transmitted to a control unit on a continuous basis, allowing the images to be generated in near real time.

Alternatively the images may be obtained following a delayed transmission of the recorded measurement data, either through causing a suitable delay in the measurement data in a continuous signal transmission, or by storing the measurement data in a suitable medium for retrieval at a later time, e.g. after retrieving the measuring apparatus from the measurement area.

The apparatus of the invention provides the possibility of collecting spectral energy information from the target object. Consequently, this information may be compared with a database containing known spectral analysis information for the types of material in question.

The apparatus of the invention comprises components that are required to generate images from a fluid-carrying pipe in which known video camera technology can not be used due to the inability of ordinary light to penetrate the fluid contents of the pipe.

The principle of the apparatus and a method according to the invention is to generate an image of a downhole target object by producing high-energy photons which are subsequently detected by bireflection from the surface and internal structures of the target object. The photons have an energy that allows transmission of said photons through materials with a low electron density, such as mud, saline solutions, hydrocarbons and more. The detected reflected photons are converted into images that can be displayed on a viewing screen.

The apparatus comprises the following principal components:
A control unit on the surface
A signal/power cable between the control unit on the surface and a downhole unit.
A downhole source and recording unit.

Alternatively the apparatus comprises the following principal components:
A downhole source and recording unit with start/stop controlled by a time switch, pressure sensor, hydroacoustic receiver or similar.
A control unit on the surface.

The following describes a non-limiting example of a preferred embodiment illustrated in the accompanying drawing, in which:

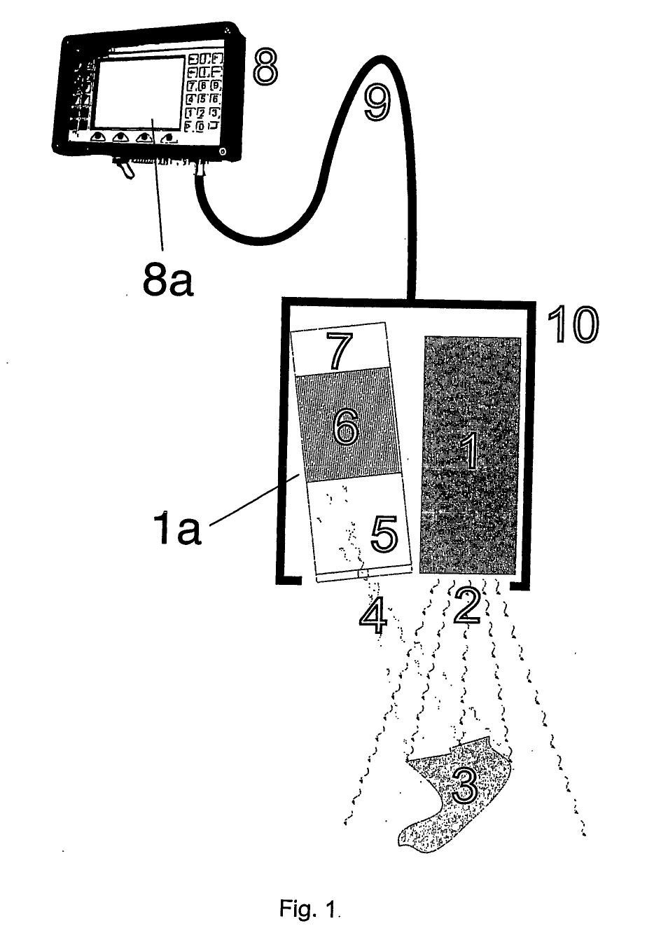

FIG. 1 shows a schematic diagram of an apparatus according to the invention.

A downhole unit 10 comprises a cooling unit (not shown), a light source 1 and a sensor unit 1a consisting of a scatter limiting aperture 5, a scintillator/amplifier unit 6 and a charge coupled device (CCD) or a photodiode assembly (PDA) 7. The light source 1 produces high-energy photons 2 having a wavelength greater than 1×10⁻¹¹ m (0.01 nanometres). These illuminate a downhole target object 3. Photons that result from bireflection 4 (i.e. reflection, decelerating radiation, scatter and/or Compton scatter) from the electron density of a downhole object 3 pass through the aperture 5 and interact with the surface of the scintillator/amplifier unit 6. The resulting photons, the majority of which have wave lengths of more than 1×10⁻⁸ m (10 nanometres) due to the effect of the scintillator on the incident reflected radiation, interact with the cell composition of the CCD/PDA 7, producing a cellular electronic charge, the magnitude and character of which are proportional to the intensity of the spectral energy of the incoming photons 4.

The accumulated electronic charge that arises in the cells of the CCD/PDA 7 is collected in a holding buffer in the CCD 7, where the individual cellular electronic potentials are temporarily stored. The content of the buffer is then transmitted through a control/power cable 9 to a surface mounted control and display unit 8 where a raster image is displayed on a viewing screen 8a. The process is continuous, with the CCD 7 being sampled and cleared several times per second.

The angle of the sensor unit 1a relative to the source 1 can be adjusted from the control and display unit 8 on the surface in order to determine the distance to the target object.

Any overall attenuation caused by high energy photons interacting with downhole fluids such as saline solutions, mud and hydrocarbons, can be filtered from the displayed image, either by increasing the clearing rate from the CCD 7 or through processing the image on the surface by means of the control and display unit 8.

The apparatus also provides the possibility of gathering spectral energy information from the incoming photons 4. The photons 4 carry information regarding the electron energy level of the atoms in the target object 3. Consequently, the distribution and magnitude of the received energy spectra can be processed versus spectra from a database for relevant types of material, these data being stored in the control and display unit 8 or possibly in an external data storage unit (not shown) that communicates with the control and display unit 8. The selection of the image area that is to be subjected to data comparison is carried out with appropriate, previously known means (not shown).

Prior art offers the operators of well inspection equipment few opportunities for receiving accurate visual feedback from the hole. In consequence, most operations are carried out blind, which is time consuming and entails a higher risk of material damage. In extreme cases the contents of the well must be removed and replaced with fluids that give better visibility for a video camera, which increases the overall cost of the well.

The apparatus provides the operator with direct visual feedback without requiring any disturbances in the condition of the well (i.e. displacement of fluid and cleaning). Accordingly, use of the apparatus will entail a great reduction in labour and cost with a view to intervention operations. The possibility of receiving quick and realistic feedback represents an important advantage over prior art.

The apparatus also provides the possibility of gathering spectral energy information from the incoming photons 4. These photons 4 contain information regarding the electronic energy level of the atoms in the target object. Thus, the acquired data can be compared with known material data. This means that an operator of the equipment according to the invention can point and click on the target object such as it appears in the generated images and by so doing, obtain information regarding the material to be examined, such as scale (contamination), reservoir structure inspection, the effect of perforations and more.

Such information may be of inestimable value to operators who wish to know the composition of such materials without having to bring them up to the surface for a closer examination and laboratory testing. This may also be of particular benefit prior to a scale clean-up, where the likelihood of radioactive scale residue being brought to the surface is high. The apparatus allows such scale to be examined prior to cleaning up, so that the operator can prepare the receiving area in accordance with the nature of the material.

As a result of the nature of the apparatus and the possibility of creating images through downhole liners, the apparatus may obviously also be used to see behind liner walls.

In many instances, items are dropped or become jammed in the wellbore during intervention and drilling operations. Known pull-out or extraction technique comprises the use of an indicator block that is conveyed into the hole to press against the dropped or jammed item in order to obtain an imprint of the top surface of the item. Examination of the imprint on the indicator block allows the operator to select the most appropriate gripping tool for extracting the item.

The apparatus of the invention can quickly provide a dynamic image of the object, which offers advantageous information such as specific identification, the interface dimensions of the target object, contaminating deposits, possible damage to the well structure and the well conditions. Due to its flexibility the apparatus may also be integrated into or coupled directly to the pull-out tool, thus allowing identification and pull-out to be accomplished in a single operation.

The apparatus of the invention may be used actively in fishing operations where items require either activation or extraction to the surface. Thus the apparatus allows considerable advantages in terms of costs and safety, and provides the operator with the possibility of receiving visual feedback on the execution of the operation. Therefore the risk of material damage will be reduced, while the speed at which the operation is carried out can be increased.

The apparatus may be used as a means of conveyance in order to carry other sensors such as temperature, pressure and flow sensor assemblies, thus forming a downhole diagnostic tool.

1. An apparatus for recording and displaying images of and identifying material types in a target object in a fluid carrying conduit, the apparatus comprising:
a downhole unit that includes a controllable light source, the controllable light source structured to emit high energy photons, the downhole unit further including a sensor unit structured to detect the high energy photons that are backscattered from the target object and to generate signals in response to the detected high energy photons; and
a control and display unit that includes a signal transmitter and a viewing screen structured to display at least one two-dimensional image that is generated using the signals from the sensor unit.

2. The apparatus of claim 1, the controllable light source structured to emit x-ray radiation.

3. The apparatus of claim 1, the controllable light source structured to emit gamma radiation.

4. The apparatus of claim 1, the sensor unit comprising:
a scatter limiting aperture;
an amplifier unit; and
an image registering device structured to generate cellular electronic charges.

5. The apparatus of claim 4, the image registering device comprising a charge coupled device.

6. The apparatus of claim 4, the image registering device comprising a photodiode assembly.

7. The apparatus of claim 1, the control and display unit further comprising:
a means for selecting imagery;
a connection to a material database; and
a processor for comparing imagery.

8. The apparatus of claim 1, the signal transmitter comprising a signal/power cable.

9. The apparatus of claim 1, the signal transmitter comprising a read unit for a computer storage device.

10. The apparatus of claim 1, the sensor unit and light source structured such that an angle of the sensor unit relative to the light source is adjustable.

11. The apparatus of claim 10, the control and display unit structured to remotely control the angle of the sensor unit relative to the light source when the downhole unit is positioned within the fluid carrying conduit and when the control and display unit is positioned outside the fluid carrying conduit.

12. The apparatus of claim 8, the downhole unit structured to be connected to the control and display unit with the signal/power cable.

13. The apparatus of claim 1, the at least one two-dimensional image generated after a predefined interval of time.

14. The apparatus of claim 1, the downhole unit connected to or integrated in a downhole tool.

15. A method of recording and displaying images of and identifying material types in a target object disposed inside a fluid-carrying conduit, the method comprising:
emitting high-energy photons from a controllable light source towards the target object;
registering photons that are backscattered from the target object using a sensor having a scatter limiting aperture, an amplifier, and an image registering device structured to generate cellular electronic charges in response to the registered photons;
transmitting image data to a control and display unit via a buffer memory integrated in the image registering device, the image data corresponding to the cellular electronic charges;
generating images on a screen in response to the transmitted image data; and
comparing selected image data with a material database for determining the material composition of the target object by spectroscopic analysis of the returning photons.

16. The method of claim 15, wherein emitting the high-energy photons comprises emitting photons having a wavelength corresponding to x-ray radiation.

17. The method of claim 15, wherein emitting the high-energy photons comprises emitting photons having a wavelength corresponding to gamma radiation.

18. The method of claim 15, wherein transmitting the image data occurs in near real time.

19. The method of claim 15, wherein transmitting the image data occurs after an arbitrary time lag.
